(19) United States
(12) Patent Application Publication
(10) Pub. No.: US 2013/0193126 A1
(43) Pub. Date: Aug. 1, 2013

(54) MOTORIZED WIRE SPOOL FOR A WIRE FEEDER

(71) Applicant: Stephen L. Anderson, Traverse City, MI (US)

(72) Inventor: Stephen L. Anderson, Traverse City, MI (US)

(73) Assignee: Illinois Tools Works Inc., Glenview, IL (US)

(21) Appl. No.: 13/360,331

(22) Filed: Jan. 27, 2012

(51) Int. Cl. B23K 9/12

(52) U.S. Cl. 219/137.2

(57) ABSTRACT

A wire feeder includes a wire spool motor. The wire spool motor is configured to rotate a wire spool. The wire feeder also includes a motor control assembly configured to control rotation of the wire spool motor. The motor control assembly includes a control arm and a biasing member. The biasing member being configured to exert a force on the control arm to direct the control arm away from a forward control position. The wire feeder includes an enclosure housing the wire spool motor and the motor control assembly.

### BACKGROUND

The invention relates generally to wire feeders and, more particularly, to a motorized wire spool for a wire feeder.

Welding is a process that has become increasingly ubiquitous in various industries and applications. While such processes may be automated in certain contexts, a large number of applications continue to exist for manual welding operations. Such welding operations rely on a variety of types of equipment to ensure the supply of welding consumables (e.g., wire feed, shielding gas, etc.) is provided to the weld in an appropriate amount at the desired time. For example, metal inert gas (MIG) welding typically relies on a wire feeder to ensure a proper wire feed reaches a welding torch. MIG welding also relies on gas-channeling tubes or cables for routing shielding gas to the torch during the time a welding arc is created between the wire and a workpiece.

Wire feeders are used to provide welding wire to a welding torch. Generally, when a torch trigger is actuated, the wire feeder provides welding wire and, when the torch trigger is released, the wire feeder stops providing welding wire. Rollers within the wire feeder pull welding wire from a wire spool to provide the welding wire to the welding torch. Often, one or more of the rollers is motorized in order to pull the welding wire from the spool. When a welding operator initiates a welding arc using the welding torch, the rollers are rotated quickly to provide welding wire to the welding torch. Thus, the motorized roller accelerates rapidly in an attempt to meet the demands of the welding torch. Unfortunately, the motorized roller may not provide welding wire within a desired amount of time.

When the welding operator terminates a welding arc, the rollers quickly stop. As will be appreciated, when this happens the momentum of the wire spool may cause it to continue to rotate. To inhibit the wire spool from rotating at undesirable times, the wire spool may use mechanically or electrically powered brakes to stop the wire spool, such as when the welding arc is terminated. Unfortunately, the brakes may place a constant drag on the wire spool, even when rotation is desired, in order to be able to stop the wire spool quickly. As a result, the roller motor is inclined to provide additional rotational energy to overcome the drag placed on the wire spool by the brakes.

When a welding torch trigger is actuated and delivery of welding wire is demanded, the roller motor accelerates the wire spool to a desired operating speed by pulling directly on the wire. As will be appreciated, the amount of force applied by the roller motor varies with the weight of the spool of wire (e.g., the force depends on whether the spool is full, nearly empty, or somewhere in-between). Further, the total force applied by the roller motor to turn the spool is a combination of the forces necessary to overcome friction, to overcome brake drag, and to accelerate the mass of the spool. As such, the total force to turn the spool is directly correlated to the distance from the surface of the wire on the spool to the rotational axis of the spool. For example, the distance from the surface of the wire on the spool to the rotational axis of the spool diminishes as the wire is consumed during a welding application. Consequently, due to the decreasing volume of wire on the spool, the pulling force needed to accelerate the mass of the wire and spool decreases. However, the pulling force on the wire needed to overcome friction and brake drag increases due to a decrease in the leverage used to rotate the spool, thereby increasing the total force needed to rotate the spool. Accordingly, there exists a need for wire feeders that overcome such disadvantages.

### BRIEF DESCRIPTION

In one embodiment, a wire feeder includes a wire spool motor configured to rotate a wire spool. The wire feeder also includes a motor control assembly configured to control rotation of the wire spool motor. The motor control assembly includes a control arm and a biasing member. The biasing member being configured to exert a force on the control arm to direct the control arm away from a forward control position. The wire feeder includes an enclosure housing the wire spool motor and the motor control assembly.

In another embodiment, a method for feeding welding wire from a wire feeder includes rotating a wire roller motor in a first direction in response to initiation of a wire welding application to provide welding wire to the welding application. The method also includes adjusting a position of a control arm to a forward control position after the wire roller motor begins rotating. The position of the control arm is adjusted to the forward control position when a first force applied to the control arm by the welding wire is greater than a second force applied to the control arm by a biasing member. The method includes rotating a wire spool motor to provide welding wire after the control arm adjusts to the forward control position.

In another embodiment, a wire tensioner assembly for a wire feeder includes a wire spool motor configured to rotate a wire spool. The wire tensioner assembly also includes a motor control assembly configured to control rotation of the wire spool motor. The motor control assembly includes a control arm and a biasing member. The biasing member being configured to exert a force on the control arm to direct the control arm away from a forward control position.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an embodiment of a welding system in accordance with aspects of the present disclosure;

FIG. 2 is a side view of an embodiment of a wire feeder in accordance with aspects of the present disclosure;

FIG. 3 is a side view of the wire feeder of FIG. 2 with the wire spool rotating in a first direction;

FIG. 4 is a side view of the wire feeder of FIG. 2 with the wire spool rotating in a second direction;

FIG. 5 is a side view of an embodiment of a motor control assembly in accordance with aspects of the present disclosure; and

FIG. 6 is a flow chart of an embodiment of a method for feeding welding wire from a wire feeder in accordance with aspects of the present disclosure.

### DETAILED DESCRIPTION

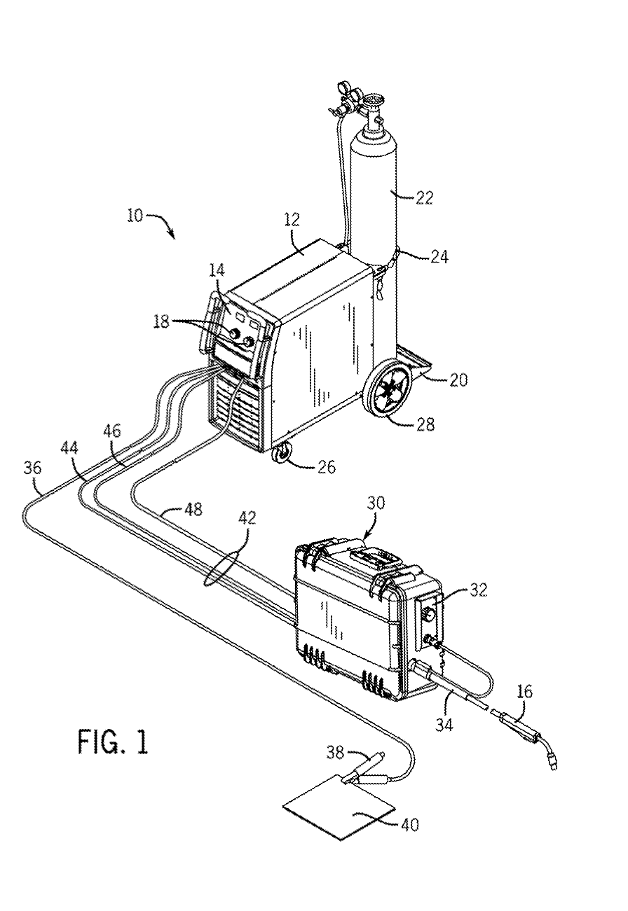

Turning now to the figures, FIG. 1 illustrates an embodiment of a welding system 10 which powers, controls, and provides supplies of welding materials to a welding operation. The welding system 10 includes a welding power supply 12 having a control panel 14 through which a welding operator may control the supply of welding materials, such as gas flow, wire feed, and so forth, to a welding torch 16. To that end, the control panel 14 includes input or interface devices, such as a user interface 18 (e.g., knobs, dials, touch screen, etc.) that the operator may use to adjust welding parameters (e.g., voltage, current, etc.). The welding power supply 12 may also include a tray 20 mounted on a back of the power supply 12 and configured to support a gas cylinder 22 held in place with a securing mechanism 24 (e.g., chain). The gas cylinder 22 is the source of the gas supplied to the welding torch 16. Furthermore, the welding power supply 12 may be portable via a set of smaller front wheels 26 and a set of larger back wheels 28 (or any combination of wheel sizes 26 and 28), which enable the operator to move the power supply 12 to the location of the weld.

The welding system 10 also includes a wire feeder 30 that provides welding wire to the welding torch 16 for use in the welding operation. The wire feeder 30 may include a control panel 32 that allows the user to set one or more wire feed parameters, such as wire feed speed. Additionally, the wire feeder 30 may house a variety of internal components, such as a wire spool, a spool motor, a motor control assembly, rollers, a roller motor, and so forth. These internal components may be configured to provide welding wire to the welding torch 16 in a more efficient manner than in other systems. For example, the wire feeder 30 may include the spool motor coupled to the wire spool. The spool motor is controlled by the motor control assembly. The motor control assembly and spool motor work together to provide tension to the welding wire. Specifically, the motor control assembly controls whether, and in what direction, the spool motor rotates. As such, the motor control assembly and the spool motor eliminate the need for electrically and/or mechanically controlled brakes attached to the wire spool. Further, the motor control assembly acts as an accumulator to aid the roller motor in quickly providing welding wire to a welding application. Using such devices, the wire feeder 30 may overcome deficiencies found in other wire feeders. As will be appreciated, the wire feeder 30 may be used with any wire feeding process, such as gas operations (gas metal arc welding (GMAW)) or gasless operations (shielded metal arc welding (SMAW)). For example, the wire feeder may be used in metal inert gas (MIG) welding or tungsten inert gas (TIG) welding.

A variety of cables and conduits couple the components of the welding system 10 together and facilitate the supply of electrical power and welding materials to the welding torch 16. A first cable 34 couples the welding torch 16 to the wire feeder 30. A second cable 36 couples the welding power supply 12 to a work clamp 38 that connects to a workpiece 40 to complete the circuit between the welding power supply 12 and the welding torch 16 during a welding operation. A bundle 42 of cables and conduits couples the welding power supply 12 to the wire feeder 30 and provides weld materials for use in the welding operation. The bundle 42 includes a welding power cable 44, a gas hose 46, and a control cable 48. The control cable 48 may be any suitable type of control cable. It should be noted that the bundle 42 of cables and conduits may not be bundled together in some embodiments.

It should be noted that modifications to the welding system 10 of FIG. 1 may be made in accordance with aspects of the present invention. For example, the tray 20 may be eliminated from the welder 12 and the gas cylinder 22 may be located on an auxiliary support cart or in a location remote from the welding operation. Furthermore, although the illustrated embodiments are described in the context of a MIG welding process, the features of the invention may be utilized with a variety of other suitable welding systems and processes.

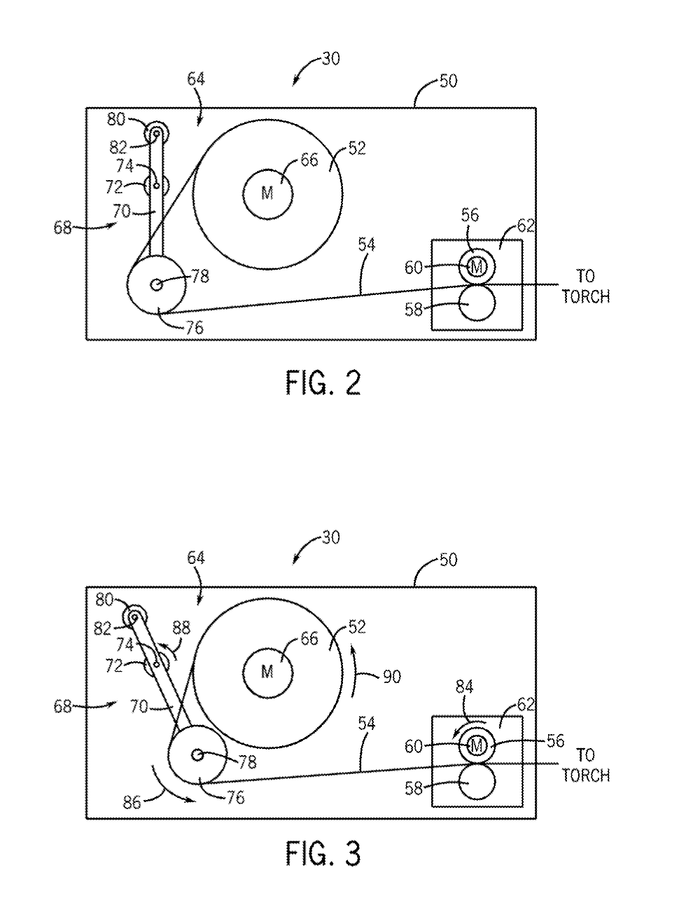

FIG. 2 is a side view of an embodiment of the wire feeder 30. An enclosure 50 is used to house the components of the wire feeder 30. As illustrated, the wire feeder 30 includes a wire spool 52 which provides welding wire 54 to the welding torch 16. As used herein, “wire spool” refers to any type of spool of welding wire regardless of the material that the spool is made from. For example, the wire spool 52 may be made from wire, plastic, metal, etc. To direct the welding wire 54 to the welding torch 16, the welding wire 54 is pulled through rollers 56 and 58 by a motor 60 coupled to one or more of the rollers 56 and 58. As will be appreciated, a wire feeding mechanism other than rollers 56 and 58 and the motor 60 may be used to direct welding wire 54 to the welding torch 16. In certain configurations, the wire feeder 30 includes control circuitry 62. The control circuitry 62 controls the operation of the motor 60. For example, the control circuitry 62 may receive an indication from the welding torch 16 that indicates whether a trigger of the torch 16 is actuated. Based on this indication, the control circuitry 62 may start and/or stop rotation of the motor 60.

A wire tensioner assembly 64 is used to provide tension to the welding wire 54. Specifically, the wire tensioner assembly 64 maintains tension on the welding wire 54 between the wire spool 52 and the rollers 56 and 58. The wire tensioner assembly 64 includes a wire spool motor 66. The wire spool 52 is coupled to the wire spool motor 66 and the wire spool motor 66 rotates the wire spool 52 during operation of the wire feeder 30. The wire spool motor 66 may rotate in either a clockwise or a counter-clockwise direction. In the present embodiment, the wire spool motor 66 rotates the wire spool 52 in a counter-clockwise direction to aid in unwinding welding wire 54 from the wire spool 52. As illustrated, if the wire spool motor 66 rotates the wire spool 52 in a clockwise direction, welding wire 54 is wound onto the wire spool 52. As will be appreciated, the wire spool 52 may be installed in a reversed position so that rotation in the clockwise direction aids in unwinding welding wire 54 from the wire spool 52, and rotation in the counter-clockwise direction winds welding wire 54 onto the wire spool 52.

The wire tensioner assembly 64 also includes a motor control assembly 68. The motor control assembly 68 controls the rotation of the wire spool motor 66. As illustrated, the motor control assembly 64 includes a control arm 70 coupled to a hub 72 via a fastener 74. A central portion of the control arm 70 is rotatably mounted to the hub 72. The hub 72 may include various electrical and/or mechanical devices. For example, the hub 72 may include a potentiometer (or another suitable device for providing feedback based on a position) and/or a biasing member. The potentiometer may be used to provide a control signal from the motor control assembly 64 to the wire spool motor 66 to control whether the spool motor 66 rotates in a forward direction, rotates in a reverse direction, or does not rotate. Further, the potentiometer may be used to determine a rate of rotation of the wire spool motor 66 (e.g., further rotation of the potentiometer results in a faster rate).

The biasing member is used to exert a force on the control arm 70 to direct the control arm 70 away from a forward control position (e.g., position of the control arm 70 that directs forward rotation of the spool motor 66). Further, the biasing member may direct the control arm 70 toward a neutral control position (e.g., position of the control arm 70 that directs no rotation of the spool motor 66) and/or a reverse control position (e.g., position of the control arm 70 that directs reverse rotation of the spool motor 66). The biasing member also is used to control a wire tension between the rollers 56 and 58 and the wire spool 52. As will be appreciated, the biasing member may include a linear potentiometer, rotary potentiometer, torsion spring, linear spring, air cylinder, and so forth.

The hub 72 may act as a pivot or rotational axis for the control arm 70. As illustrated, the axis of the control arm 70 is generally parallel to a rotational axis of the spool motor 66. A wire guide 76 (e.g., pulley) is coupled to the control arm 70 on a first end via a fastener 78. The wire guide 76 is used to route the welding wire 54 to the rollers 56 and 58. In certain embodiments, the wire guide 76 may have a diameter of approximately 3 to 7 inches. Further, a counter weight 80 is coupled to the control arm 70 on a second end via a fastener 82. The counter weight 80 provides a weight to balance the weight of the wire guide 76 so that the wire feeder 30 will operate properly even if the wire feeder 30 is not on a level surface. For example, the counter weight 80 may make it so the wire feeder 30 will operate properly on its side, or upside down. Further, the counter weight 80 aids in balancing the control arm 70 and the biasing member to cause the control arm 70 to be neutral to the force of gravity such that the mechanical functioning of the assembly is unaffected by the orientation of the wire feeder 30.

The welding wire 54 extends off of the wire spool 52, around the wire guide 76, and through the rollers 56 and 58. As will be appreciated, the motor control assembly 68 is used to apply a tension force onto the welding wire 54. For example, the motor control assembly 68 may provide a constant back pressure (e.g., force) against the welding wire 54 of approximately 6 ounces. The back pressure may be adjustable for tailoring the wire feeder 30 to the needs of a particular welding application. The tension applied by the motor control assembly 68 aids in eliminating slack in the welding wire 54. In certain embodiments, the motor control assembly 68 (e.g., using the biasing member) may exert a back pressure that varies within a predetermined range during operation. For example, the motor control assembly 68 may exert a back pressure that varies between approximately 4 and 10 ounces.

FIG. 3 is a side view of the wire feeder 30 of FIG. 2 with the wire spool 52 being rotated in a first direction. During operation, the wire feeder 30 receives an indication that the trigger of the welding torch 16 is actuated. This causes the roller motor 60 to rotate the roller 56 in a counter-clockwise direction 84. When rotation of the roller 56 starts, the motor control assembly 68 may be in the neutral control position illustrated in FIG. 2. As welding wire 54 is pulled through the rollers 56 and 58, the welding wire 54 directs the wire guide 76 toward the rollers 56 and 58 as shown by arrow 86 of FIG. 3 and causes the control arm 70 to rotate in a counter-clockwise direction 88. Thus, the motor control assembly 68 rotates to a forward control position. In the forward control position, the motor control assembly 68 directs the spool motor 66 to rotate. Rotation of the spool motor 66 induces rotation of the wire spool 52 in a counter-clockwise direction 90 allowing the welding wire to be pulled from the wire spool 52 with a very small and generally constant resistant force. As discussed above, the motor control assembly 68 may include a potentiometer, or some other device, that provides signals to the spool motor 66 to control its rotation. Adjustment of the potentiometer may result in either forward or reverse rotation of the spool motor 66. For example, as the motor control assembly 68 moves from the neutral control position to the forward control position, the motor control assembly 68 may rotate the potentiometer resulting in the spool motor 66 rotating in the forward direction (e.g., counter-clockwise in the present embodiment).

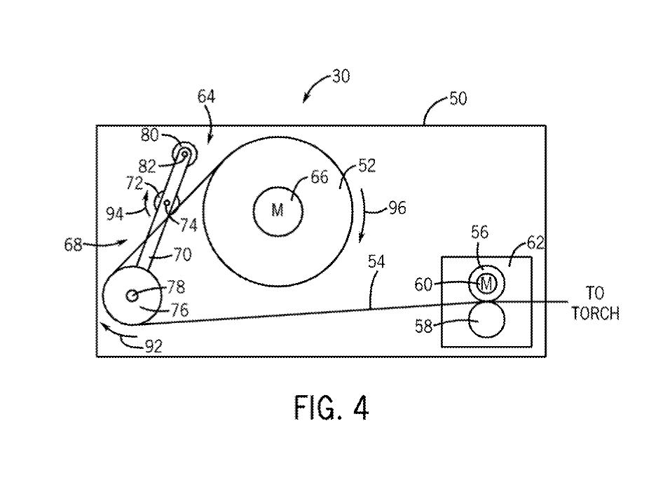

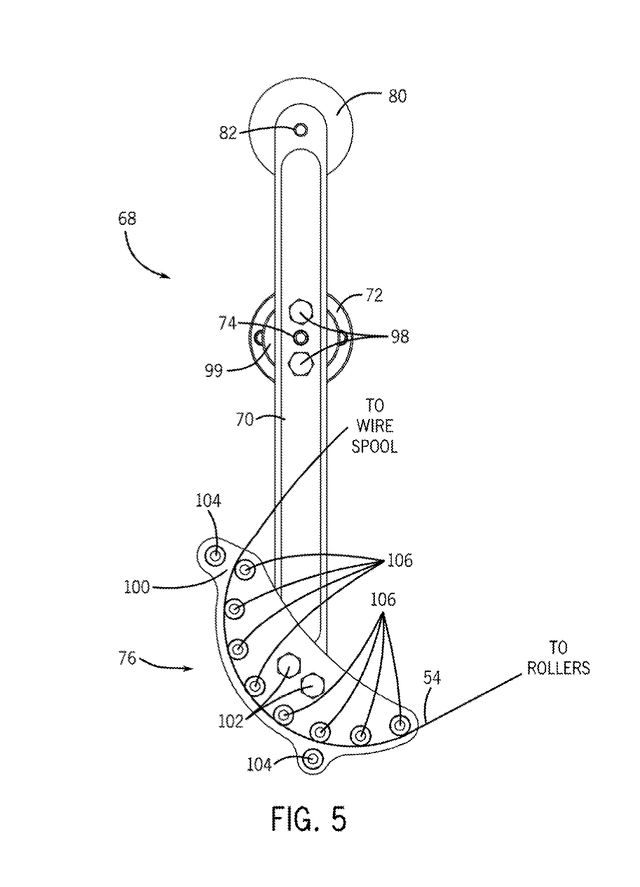

FIG. 4 is a side view of the wire feeder 30 of FIG. 2 with the wire spool 52 rotating in a second direction. During operation, the wire feeder 30 may receive an indication that the trigger of the welding torch 16 is no longer actuated. This results in the roller motor 60 halting or stopping rotation of the roller 56. When rotation of the roller 56 stops, the force exerted on the motor control assembly 68 by the welding wire 54 will be exceeded by the force exerted (e.g., by the biasing member) and the motor control assembly 68 may begin to move clockwise to the neutral control position illustrated in FIG. 2 inhibiting slack in the welding wire 54. In the neutral control position, the motor control assembly 68 may direct the spool motor 66 to stop rotating. As continued tension is applied (e.g., by the biasing member) to the control arm 70, the wire guide 76 moves away from the rollers 56 and 58 as shown by arrow 92 of FIG. 4 and causes the control arm 70 to rotate in a clockwise direction 94. Thus, the motor control assembly 68 rotates to a reverse control position. In the reverse control position, the motor control assembly 68 directs the spool motor 66 to rotate in a reverse direction. As such, rotation of the spool motor 66 induces rotation of the wire spool 52 in a clockwise direction 96 and applies increasing force on the welding wire 54. Such an increasing force on the welding wire 54 opposes the tension applied (e.g., by the biasing member) causing the motor control assembly 68 to rotate counter-clockwise to a position on the reverse side of the neutral control position. In such a position, the motor control assembly 68 rests while applying a predetermined tension to the welding wire 54. In certain embodiments, the control arm 70 may alternate between the neutral control position and the reverse control position to maintain the predetermined tension in the welding wire 54. As will be appreciated, the motor control assembly 68 may rotate a potentiometer which results in the spool motor 66 rotating in the reverse direction (e.g., clockwise in the present embodiment).

FIG. 5 is a side view of an embodiment of the motor control assembly 68. In this embodiment, the control arm 70 is rotatably coupled to the hub 72 using fasteners 98. The hub 72 includes a biasing member 99 that exerts a force on the control arm 70 to direct the control arm 70 away from the forward control position. As previously discussed, the biasing member 99 may include a linear potentiometer, rotary potentiometer, torsion spring, linear spring, air cylinder, and so forth. The wire guide 76 of the present embodiment includes a roller assembly 100 coupled to the control arm 70 via fasteners 102. The roller assembly 100 includes wheels 104 and 106. The wheels 104 and 106 are cylindrical structures that rotate when an object moves along their surface. As illustrated, the welding wire 54 is inserted between the wheels 104 and 106 to extend the welding wire 54 from the wire spool 52 to the rollers 56 and 58.

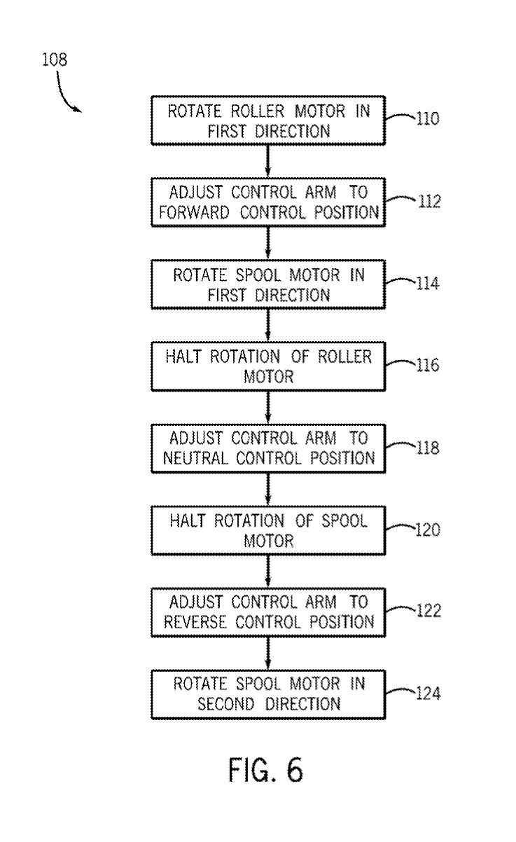

FIG. 6 is a flow chart of an embodiment of a method 108 for feeding welding wire 54 from the wire feeder 30. In block 110, the roller motor 60 is rotated in a first direction to feed welding wire 54 to a welding application in response to a welding operator actuating a torch trigger. Then, at block 112, as welding wire 54 is pulled across the wire guide 76, the control arm 70 is adjusted to a forward control position. As previously discussed, the control arm 70 exerts a back pressure against the welding wire 54 to maintain tension on the welding wire 54. In certain embodiments, the position of the control arm 70 is adjusted to the forward control position when a force applied to the control arm 70 by the welding wire 54 is greater than the back pressure applied to the control arm 70 by the biasing member 99. Next, at block 114, the spool motor 66 is rotated in the first direction (e.g., as a result of the control arm 70 being moved to the forward control position). At block 116, the rotation of the roller motor 60 is stopped or halted, such as in response to the welding operator releasing the torch trigger. Then, at block 118, the control arm 70 is adjusted to a neutral control position (e.g., as a result of the force being applied to the welding wire 54, such as by the biasing member 99). Next, at block 120, the rotation of the spool motor 66 is stopped or halted, due to the control arm 70 rotating to the neutral control position.

At block 122, the control arm 70 is adjusted to a reverse control position (e.g., as a result of force being applied to the control arm 70, such as by the biasing member 99). Then, at block 124, the spool motor 66 is rotated in a second direction 124 (e.g., as a result of the control arm 70 being moved to the reverse control position). By rotating in the second direction 124 (e.g., reverse), the spool motor 66 applies force to the control arm 70 by the welding wire 54 to counter the force applied to the control arm 70 by the biasing member 99. The spool motor 66 also adjusts the position of the control arm 70 to a stationary position (e.g., a position where the control arm 70 has little or no movement and held in place by the spool motor 66 rotating in the second direction 124). Thus, the spool motor 66 provides a predetermined wire tension to the welding wire 54. As will be appreciated, the blocks of the method 108 may be arranged in a different order than presented, and the method 108 may contain fewer or more steps than described. With such a method, the wire tensioner assembly 64 is able to maintain tension on the welding wire 54 to inhibit wire loops from coming off the wire spool 52 and into the wire feeder 30. Further, by using the wire tensioner assembly 64 to replace electrical or mechanical braking, the roller motor 60 may be smaller than in systems that use the braking (due to the constant load placed on the wire spool 52 by the braking). In addition, by using the wire tensioner assembly 64 to motorize the wire spool 52, the roller motor 60 may be smaller because it is not used to accelerate the mass of the wire spool 52 up to operating speed. Further, by using the wire tensioner assembly 64, the rollers 56 and 58 may exert less pressure against the welding wire 54 to feed the welding wire 54 to a welding application resulting in less degradation in the quality of the welding wire 54 and less debris falling off the welding wire 54. As such, the wire tensioner assembly 64 overcomes various deficiencies found in certain wire feeding systems.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A wire feeder comprising:
a wire spool motor configured to rotate a wire spool;
a motor control assembly configured to control rotation of the wire spool motor, the motor control assembly comprising a control arm and a biasing member, the biasing member being configured to exert a force on the control arm to direct the control arm away from a forward control position; and
an enclosure housing the wire spool motor and the motor control assembly.

2. The wire feeder of claim 1, wherein the control arm of the motor control assembly rotates about a first axis generally parallel to a second axis of the wire spool motor.

3. The wire feeder of claim 2, wherein a central portion of the control arm is coupled to the first axis.

4. The wire feeder of claim 1, wherein the control arm comprises a wire guide coupled to a first end of the control arm and configured to direct welding wire toward a plurality of wire rollers.

5. The wire feeder of claim 1, wherein a second end of the control arm comprises a counterweight.

6. The wire feeder of claim 1, comprising a plurality of wire rollers configured to direct welding wire to a welding application.

7. The wire feeder of claim 6, wherein the biasing member of the motor control assembly is configured to control a wire tension between the plurality of wire rollers and the wire spool.

8. The wire feeder of claim 6, comprising a wire roller motor configured to rotate one of the plurality of wire rollers to provide welding wire to the welding application.

9. The wire feeder of claim 1, wherein the control arm of the motor control assembly comprises a reverse control position, the forward control position is configured to direct the wire spool motor to rotate in a first direction to provide welding wire to a welding application and the reverse control position configured to direct the wire spool motor to rotate in a second direction to provide tension to the welding wire.

10. The wire feeder of claim 1, wherein the force exerted by the biasing member varies within a predetermined range during operation.

11. A method for feeding welding wire from a wire feeder comprising:
rotating a wire roller motor in a first direction in response to initiation of a wire welding application to provide welding wire to the welding application;
adjusting a position of a control arm to a forward control position after the wire roller motor begins rotating, wherein the position of the control arm is adjusted to the forward control position when a first force applied to the control arm by the welding wire is greater than a second force applied to the control arm by a biasing member; and
rotating a wire spool motor to provide welding wire after the control arm adjusts to the forward control position.

12. The method of claim 11, comprising halting rotation of the wire roller motor in response to termination of the wire welding application.

13. The method of claim 12, comprising adjusting the position of the control arm to a reverse control position to maintain tension on the welding wire after the wire roller motor halts rotation.

14. The method of claim 13, comprising rotating the wire spool motor to retract welding wire after the control arm adjusts to the reverse control position.

15. The method of claim 12, comprising adjusting the position of the control arm to a neutral control position to maintain tension on the welding wire after the wire roller motor halts rotation.

16. The method of claim 11, comprising reversing the wire spool motor to apply a third force to the control arm by the welding wire, to counter the second force applied to the control arm by the biasing member, to adjust the position of the control arm to a stationary position, and to provide a predetermined wire tension.

17. A wire tensioner assembly for a wire feeder comprising:
a wire spool motor configured to rotate a wire spool; and
a motor control assembly configured to control rotation of the wire spool motor, the motor control assembly comprising a control arm and a biasing member, the biasing member being configured to exert a force on the control arm to direct the control arm away from a forward control position.

18. The wire tensioner assembly of claim 17, wherein the biasing member comprises a spring.

19. The wire tensioner assembly of claim 17, wherein the wire spool motor is configured to rotate in a first direction when the control arm is in a first position and to rotate in a second direction when the control arm is in a second position.

20. The wire tensioner assembly of claim 17, wherein the control arm is configured to maintain tension between a wire roller and a wire spool.
